(19) United States
(12) Patent Application Publication
(10) Pub. No.: US 2011/0243441 A1
(43) Pub. Date: Oct. 6, 2011

(54) Image Transient Improvement Apparatus

(76) Inventors: Yu-Mao Lin, Tainan City (TW); Chih-Chia Kuo, Hsinchu County (TW)

(21) Appl. No.: 13/076,451

(22) Filed: Mar. 31, 2011

(30) Foreign Application Priority Data
Mar. 31, 2010 (TW) 099109890

(51) Int. Cl. G06K 9/00

(52) U.S. Cl. 382/169; 382/168

(57) ABSTRACT

An image transient improvement apparatus for suppressing aliasing patterns in an image is disclosed. The image transient improvement apparatus includes a limit detector for detecting a maximum gray level and a minimum gray level of a plurality of pixels of a sub-zone of the image, a filter for acquiring a frequency component of the plurality of pixels at a specific frequency, a weighted second-order derivative detector for calculating a plurality of second-order derivatives of the plurality of pixels and accordingly generating a gain, a multiplier for multiplying the frequency component by the gain to generate an amplified frequency component, an adder for adding the amplified frequency component to the plurality of pixels to generate an adding result, and a limiter for converting the adding result to a transient improved sub-zone according to the maximum gray level and the minimum gray level.

### BACKGROUND OF THE INVENTION

1. Field of the Invention

The present invention is related to an image transient improvement apparatus, and more particularly, to an image transient improvement apparatus for suppressing aliasing and contour patterns in an image.

2. Description of the Prior Art

With popularity of digital recording and broadcasting equipment, the industry and consumers require more in digital image editing. For example, a transient improvement technique is utilized for suppressing image defects induced by a bad camera or poor shooting, and includes steps of detecting a blurred zone in an image and shrinking edges in the blurred zone, so as to visually sharpen patterns in the image.

Please refer to FIG. 1, which is a schematic diagram of an image transient improvement apparatus 10 of the prior art. The image transient improvement apparatus 10 includes an input end 100, a limit detector 102, a filter 104, a multiplier 106, an adder 108, a limiter 110 and an output end 112. The input end 100 is utilized for receiving pixels P(1)-P(K) of a sub-zone FRM_sub of an image FRM. The limit detector 102 is utilized for detecting a maximum gray level mx and a minimum gray level mn of the pixels P(1)-P(K). The filter 104 is utilized for extracting a frequency component FRM_f of the pixels P(1)-P(K) at a specific frequency, such as a high frequency component or a low frequency component. The multiplier 106 is utilized for multiplying the frequency component FRM_f by a constant gain G_fix to generate an amplified frequency component FRM_e. The adder 108 is utilized for calculating a sum AD of the amplified frequency component FRM_e and the pixels P(1)-P(K). The limiter 110 is utilized for generating an input-output conversion function (see FIG. 2) based on the maximum gray level mx and the minimum gray level mn and accordingly converting the sum AD into a transient improved sub-zone FRM_ti. Finally, the output end 112 outputs the transient improved sub-zone FRM_ti.

In short, the image transient improvement apparatus 10 extracts the frequency component FRM_f from the pixels P(1)-P(K) at a desired frequency by the filter 104, and controls how much the frequency component FRM_f is amplified through the multiplier 106. The adder 108 adds the amplified frequency component FRM_e to the original image FRM to visually sharpen the image FRM.

Note that, the gain G_fix is a constant. That is, regardless of whether the sub-zone FRM_sub is located in an edge pattern (high frequency) or a flat pattern (low frequency) of the image FRM, the image transient improvement apparatus 10 amplifies the sub-zone FRM_sub by the same gain. However, a gain designed for high frequency patterns does not suit low frequency patterns, and vice versa. For example, if a high gain designed for visually sharpening the edge patterns is applied to the flat patterns, contour patterns are generated in the flat patterns, resulting in discontinuity and distortion in the image FRM, as illustrated in FIG. 3. In addition, if a high gain is applied to a high frequency zone with complex sharp patterns, aliasing patterns are generated in the high frequency zone, as illustrated in FIG. 4.

Therefore, adaptively applying different gains to sub-zones characterized by different features has been a major focus of the industry.

### SUMMARY OF THE INVENTION

It is therefore a primary objective of the claimed invention to provide an image transient improvement apparatus.

The present invention discloses an image transient improvement apparatus for suppressing aliasing patterns in an image. The image transient improvement apparatus comprises an input end for receiving a plurality of pixels of a sub-zone of the image, an output end for outputting a transient improved sub-zone of the image, a limit detector coupled to the input end for detecting a maximum gray level and a minimum gray level of the plurality of pixels, a filter coupled to the input end for acquiring a frequency component of the plurality of pixels at a specific frequency, a weighted second-order derivative detector coupled to the input end and the limit detector for calculating a plurality of second-order derivatives of the plurality of pixels and generating a gain according to the plurality of second-order derivatives, a multiplier coupled to the filter and the weighted second-order derivative detector for multiplying the frequency component by the gain to generate an amplified frequency component, an adder coupled to the multiplier and the input end for calculating a sum of the amplified frequency component and the plurality of pixels, and a limiter coupled to the adder and the limit detector for generating an input-output conversion function according to the maximum gray level and the minimum gray level and converting the sum into the transient improved sub-zone.

The present invention further discloses an image transient improvement apparatus for suppressing contour patterns in an image. The image transient improvement apparatus comprises an input end for receiving a plurality of pixels of a sub-zone of the image, an output end for outputting a transient improved sub-zone of the image, a limit detector coupled to the input end for detecting a maximum gray level and a minimum gray level of the plurality of pixels, a filter coupled to the input end for acquiring a frequency component of the plurality of pixels at a specific frequency, an edge response detector coupled to the input end for calculating a plurality of first-order derivatives of the plurality of pixels and generating a gain according to the plurality of first-order derivatives, a multiplier coupled to the filter and the edge response detector for multiplying the frequency component by the gain to generate an amplified frequency component, an adder coupled to the multiplier and the input end for calculating a sum of the amplified frequency component and the plurality of pixels, and a limiter coupled to the adder and the limit detector for generating an input-output conversion function according to the maximum gray level and the minimum gray level and converting the sum into the transient improved sub-zone.

The present invention further discloses an image transient improvement apparatus for suppressing aliasing and contour patterns in an image. The image transient improvement apparatus comprises an input end for receiving a plurality of pixels of a sub-zone of the image, an output end for outputting a transient improved sub-zone of the image, a limit detector coupled to the input end for detecting a maximum gray level and a minimum gray level of the plurality of pixels, a filter coupled to the input end for acquiring a frequency component of the plurality of pixels at a specific frequency, a weighted second-order derivative detector coupled to the input end and the limit detector for calculating a plurality of second-order derivatives of the plurality of pixels and generating a de-aliasing gain according to the plurality of second-order derivatives, an edge response detector coupled to the input end for calculating a plurality of first-order derivatives of the plurality of pixels, and generating a de-contour gain according to the plurality of first-order derivatives, a gain selector coupled to the weighted second-order derivative detector and the edge response detector for generating a gain according to the de-aliasing gain and the de-contour gain, a first multiplier coupled to the gain selector and the filter for multiplying the frequency component by the gain to generate an amplified frequency component, an adder coupled to the first multiplier and the input end for calculating a sum of the amplified frequency component and the plurality of pixels, and a limiter coupled to the adder and the limit detector for generating an input-output conversion function according to the maximum gray level and the minimum gray level and converting the sum into the transient improved sub-zone.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an image transient improvement apparatus of the prior art.

FIG. 2 is a schematic diagram of an input-output conversion function of a limiter of the image transient improvement apparatus shown in FIG. 1.

FIG. 3 is a schematic diagram of contour patterns generated by the image transient improvement apparatus shown in FIG. 1 when performing an image sharpening process.

FIG. 4 is a schematic diagram of aliasing patterns generated by the image transient improvement apparatus shown in FIG. 1 when performing an image sharpening process.

FIG. 5 is a schematic diagram of an image transient improvement apparatus according to an embodiment of the present invention.

FIG. 6 is a schematic diagram of a weighted second-order derivative detector of the image transient improvement apparatus shown in FIG. 5.

FIG. 7A to FIG. 7F are schematic diagrams of pixels selected by a second-order derivative calculator of the weighted second-order derivative detector shown in FIG. 6.

FIG. 8 is a schematic diagram of a local gain versus difference curve of a normalization unit of the weighted second-order derivative detector shown in FIG. 6.

FIG. 9 is a schematic diagram of a sigmoid function of a limiter of the image transient improvement apparatus shown in FIG. 5.

FIG. 10 is a schematic diagram of an image transient improvement apparatus according to an embodiment of the present invention.

FIG. 11 is a schematic diagram of an edge response detector of the image transient improvement apparatus shown in FIG. 10.

FIG. 12 is a schematic diagram of a gain versus first-order derivative curve of a gain adapter of the edge response detector shown in FIG. 11.

FIG. 13 is a schematic diagram of an image transient improvement apparatus according to an embodiment of the present invention.

FIG. 14 is a schematic diagram of a gain selector of the image transient improvement apparatus shown in FIG. 13.

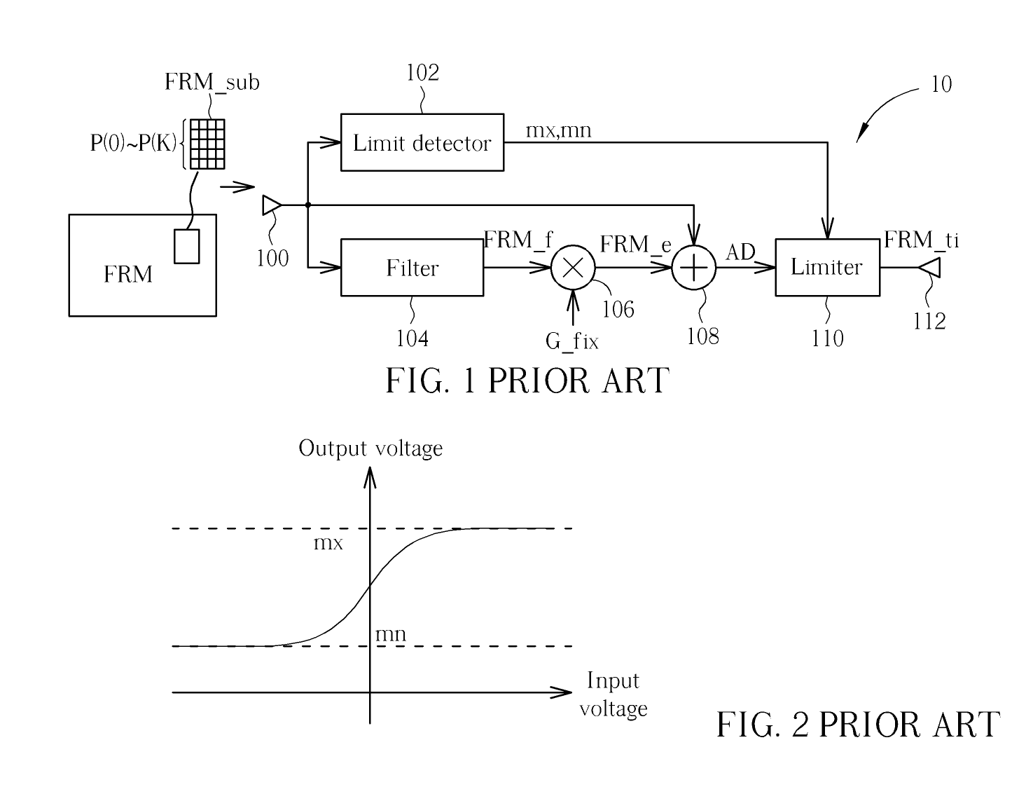

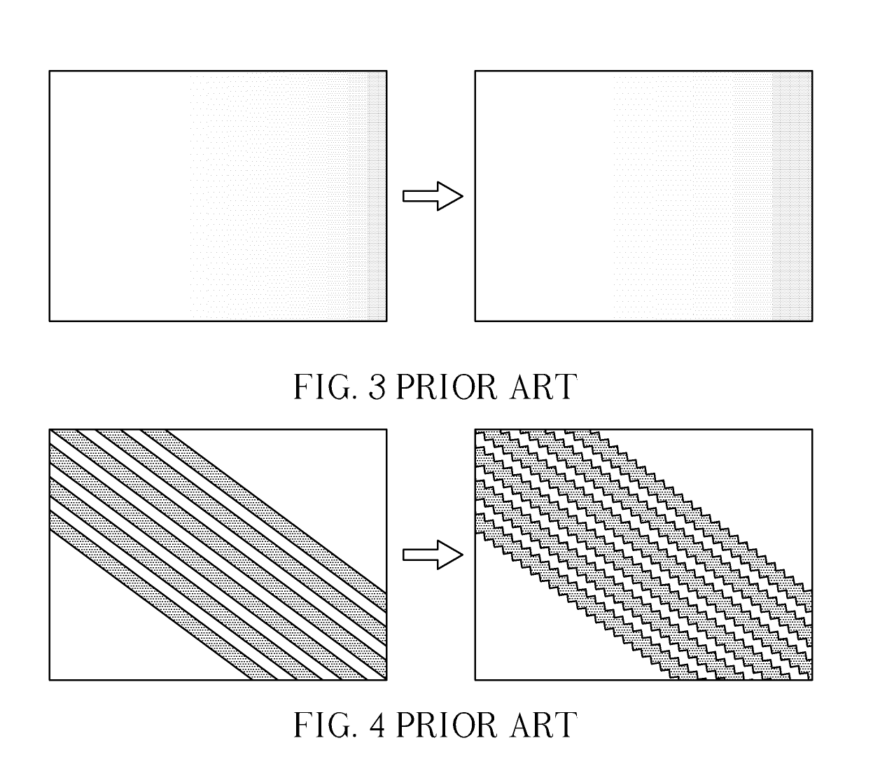

### DETAILED DESCRIPTION

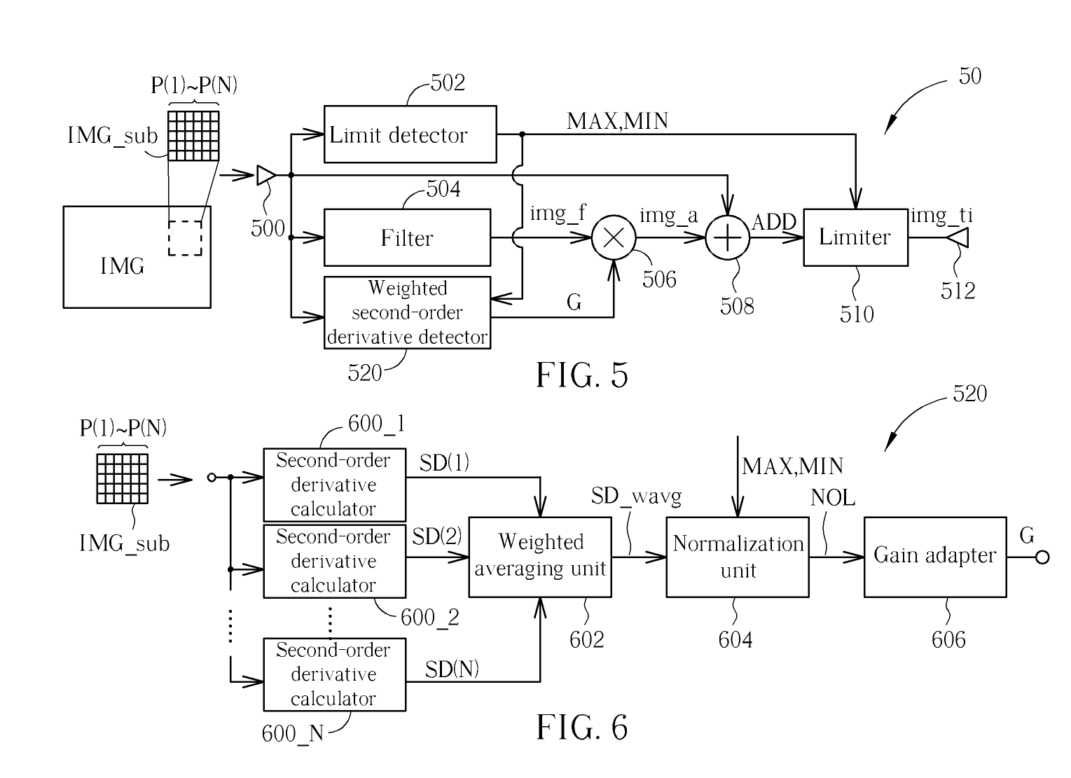

Please refer to FIG. 5, which is a schematic diagram of an image transient improvement apparatus 50 according to an embodiment of the present invention. The image transient improvement apparatus 50 is utilized for suppressing aliasing patterns in an image IMG, and includes an input end 500, an output end 512, a limit detector 502, a filter 504, a weighted second-order derivative detector 520, a multiplier 506, an adder 508 and a limiter 510. The input end 500 is utilized for receiving pixels P(1)-P(N) of a sub-zone IMG_sub of an image IMG. The output end 512 is utilized for outputting a transient improved sub-zone img_ti of the sub-zone IMG_sub. The limit detector 502 is utilized for detecting a maximum gray level MAX and a minimum gray level MIN of the pixels P(1)-P(N). The filter 504 is utilized for extracting a frequency component img_f of the pixels P(1)-P(N) at a specific frequency. The weighted second-order derivative detector 520 is utilized for calculating second-order derivatives SD(1)-SD(N) of the pixels P(1)-P(N) and accordingly generating a gain G. The multiplier 506 is utilized for multiplying the frequency component img_f by the gain G to generate an amplified frequency component img_a. The adder 508 is utilized for adding the amplified frequency component img_a to the original image (the pixels P(1)-P(N)) to generate a sum ADD. The limiter 510 is utilized for generating an input-output conversion function based on the maximum gray level MAX and the minimum gray level MIN and accordingly converting the sum ADD into the transient improved sub-zone img_ti.

In short, to avoid generating aliasing patterns during an image sharpening process, the image transient improvement apparatus 50 adaptively generates the gain G based on features of the sub-zone IMG_sub. As a result, the image IMG no longer suffers from side effects, such as aliasing texture and aliasing edges, during the image sharpening process.

In detail, please refer to FIG. 6, which is a schematic diagram of the weighted second-order derivative detector 520. The weighted second-order derivative detector 520 includes second-order derivative calculators 600_1-600_N, a weighted averaging unit 602, a normalization unit 604 and a gain adapter 606. Each of the second-order derivative calculators 600_1-600_N (representatively noted by 600_x) is utilized for calculating the second-order derivative SD(x) of one pixel P(x) of the sub-zone IMG_sub along a differential direction. The weighted averaging unit 602 is utilized for calculating a weighted average SD_wavg of the second-order derivatives SD(1)-SD(N). The normalization unit 604 is utilized for generating a local gain according to a difference between the maximum grey level MAX and the minimum grey level MIN, and multiplying the weighted average SD_wavg by the local gain to generate a normalization result NOL. Finally, the gain adapter 606 generates the gain G according to the normalization result NOL.

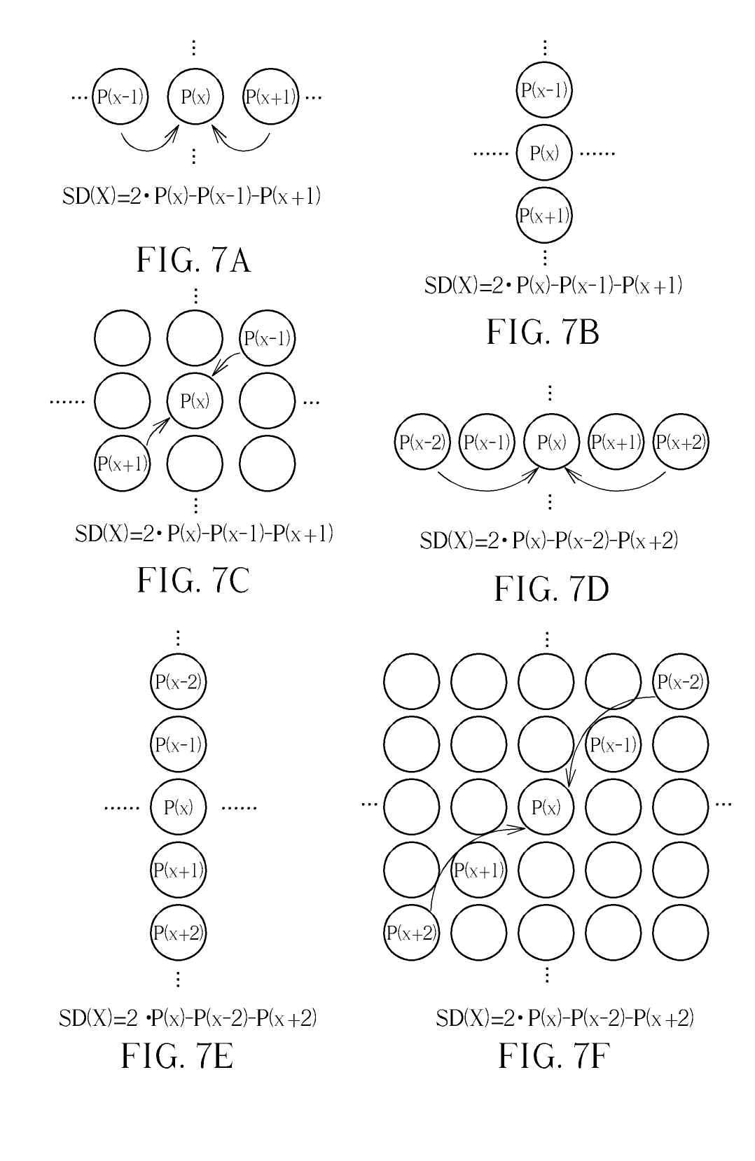

Since texture or edges of the sub-zone IMG_sub are directional, the second-order derivative calculators 600_1-600_N can calculate the second-order derivatives SD(1)-SD(N) along a horizontal direction, a vertical direction or a diagonal direction to detect high frequency variations along the different directions. More specifically, as illustrated from FIG. 7A to FIG. 7F, the second-order derivative SD(x) is calculated according to:

SD(x)=2•P(x)−P(x−1)−P(x+1) (Eq. 1)

or

2•P(x)−P(x−2)−P(x+2)

or

max{2·P(x)−P(x−1)−P(x+1)2·P(x)−P(x−(Δ+2))−P(x+(Δ+2))}

As listed from FIG. 7A to FIG. 7F and Eq.1, the formula for calculating the second-order derivatives is flexible, and can be adjusted based on practical requirements, image features, etc.

Once the second-order derivatives SD(1)-SD(N) are calculated, the weighted averaging unit 602 calculates the weighted average SD_wavg of the second-order derivatives SD(1)-SD(N). Preferably, the weighted averaging unit 602 directly calculates an average of the second-order derivatives SD(1)-SD(N) to be the weighted average SD_wavg, or calculates the weighted average SD_wavg according to:

SD_wavg=(SD(1)+SD(2)+ . . . 2SD(m)+ . . . +SD(N))/(N+1), (Eq. 2)

to weight a median SD(m) of the second-order derivatives SD(1)-SD(N).

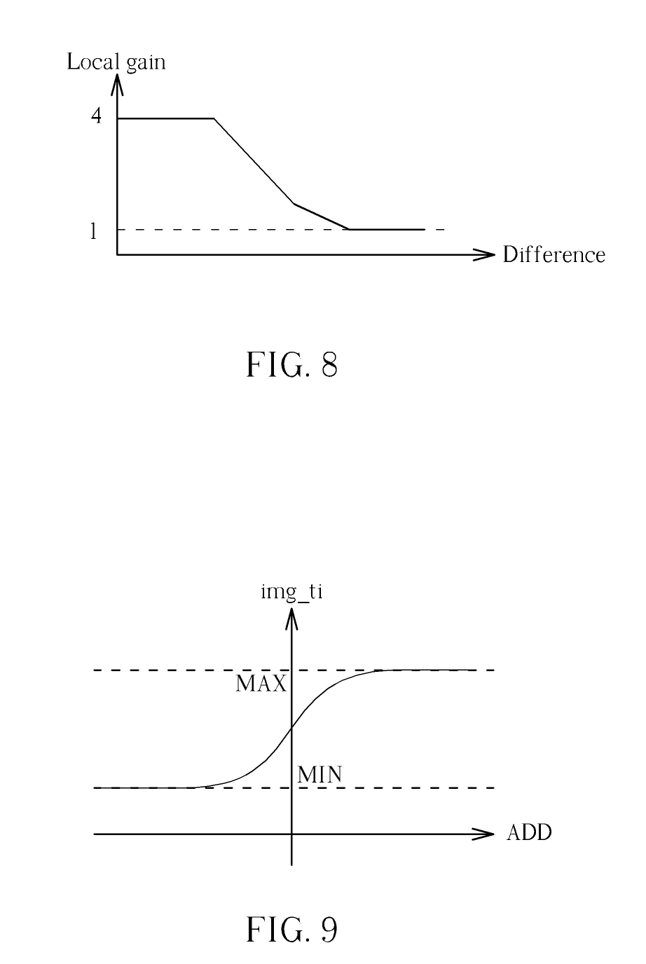

Since the difference between the maximum grey level MAX and the minimum grey level MIN stands for contrast among the pixels P(1)-P(N) of the sub-zone IMG_sub, the normalization unit 604 preferably increases the local gain when the difference is small to enhance the contrast of the sub-zone IMG_sub, as illustrated in FIG. 8. In addition, the gain adapter 606 maintains the gain G to be a standard gain when the normalization result NOL is small (implying a low frequency, flat sub-zone), and decreases the gain G when the normalization result NOL is large (implying a high frequency, bumpy sub-zone) to suppress aliasing patterns in the sub-zone IMG_sub.

Note that, if the sum ADD is greater than the maximum grey level MAX or smaller than the minimum grey level MIN of the sub-zone IMG_sub, discontinuities appear in boundaries of the sub-zones. Therefore, the limiter 510 applies a sigmoid function to be the input-output conversion function of the sum ADD and the transient improved sub-zone img_ti. Preferably, a maximum output value and a minimum output value of the sigmoid function are respectively equal to the maximum grey level MAX and the minimum grey level MIN, as illustrated in FIG. 9.

As a result, the image transient improvement apparatus 50 can detect the high frequency area in the image IMG by calculating second-order derivatives to adaptively decrease the gain G, so as to suppress aliasing patterns in the image IMG.

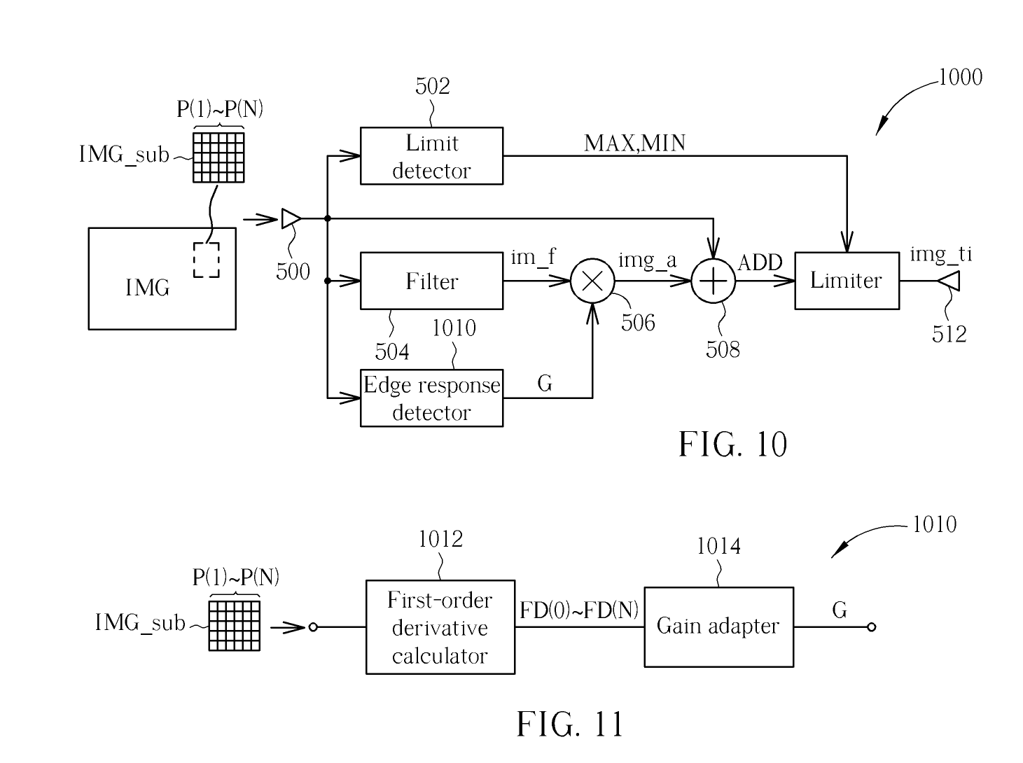

Other than the aliasing problem, contour patterns are also generated when the constant gain G_fix is applied during the image sharpening process. For that reason, the present invention further provides an image transient improvement apparatus 1000, as illustrated in FIG. 10. The image transient improvement apparatus 1000 is similar to the image transient improvement apparatus 50, and differs only in an edge response detector 1010 which replaces the weighted second-order derivative detector 520 of the image transient improvement apparatus 50. The edge response detector 1010 calculates first-order derivatives FD(1)-FD(N) of the pixels P(1)-P(N), and accordingly generates the gain G.

In short, the image transient improvement apparatus 1000 estimates an edge level of the sub-zone IMG_sub by calculating the first-order derivatives FD(1)-FD(N), and generates the gain G based on the edge level to avoid the contour patterns.

In detail, please refer to FIG. 11, which is a schematic diagram of the edge response detector 1010. The edge response detector 1010 includes a first-order derivative calculator 1012 and a gain adapter 1014. The first-order derivative calculator 1012 is utilized for calculating the first-order derivatives FD(1)-FD(N) of the pixels P(1)-P(N) along a differential direction. The gain adapter 1014 is utilized for generating the gain G according to the first-order derivatives FD(1)-FD(N).

Similarly, the first-order derivative calculator 1012 can calculate any of the first-order derivatives FD(x)=abs(P(x)−P(x−Δ)) along a horizontal direction, a vertical direction or a diagonal direction, wherein Δ represents a pixel index difference between the pixels P(x), P(x−Δ), and is equal to 4, −4, 2, −2 or the like to meet different application requirements.

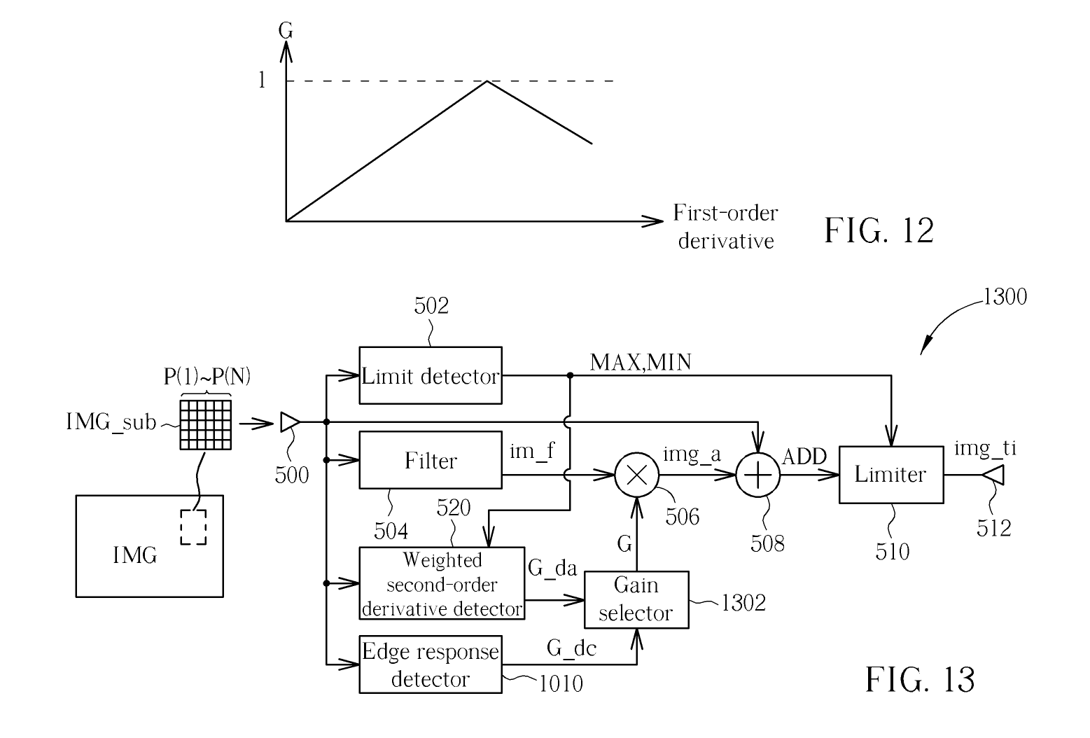

To adaptively adjust the gain G according to the edge level of the sub-zone IMG_sub, please refer to FIG. 12, which is a schematic diagram of a gain versus first-order derivative curve of the gain adapter 1014. The gain adapter 1014 decreases the gain G when the first-order derivative is small (implying a flat zone) to avoid the contour patterns in the image IMG, maintains the gain G to be a standard gain when the first-order derivative is moderate (implying an object edge) , and reduces the gain G when the first-order derivative is large (implying a sharp edge) to avoid enhancing shark edges in the image IMG.

Certainly, aliasing and contour patterns may both exist in the image IMG. Thus, the present invention further provides an image transient improvement apparatus 1300, as illustrated in FIG. 13. The image transient improvement apparatus 1300 is an integration of the image transient improvement apparatuses 50, 1000 with an additional gain selector 1302, which generates the gain G based on a de-aliasing gain G_da generated by the weighted second-order derivative detector 520 and a de-contour gain G_dc generated by the edge response detector 1010. That is, a user can choose the gain G based on characteristics of the image IMG to suppress the aliasing patterns or the contour patterns.

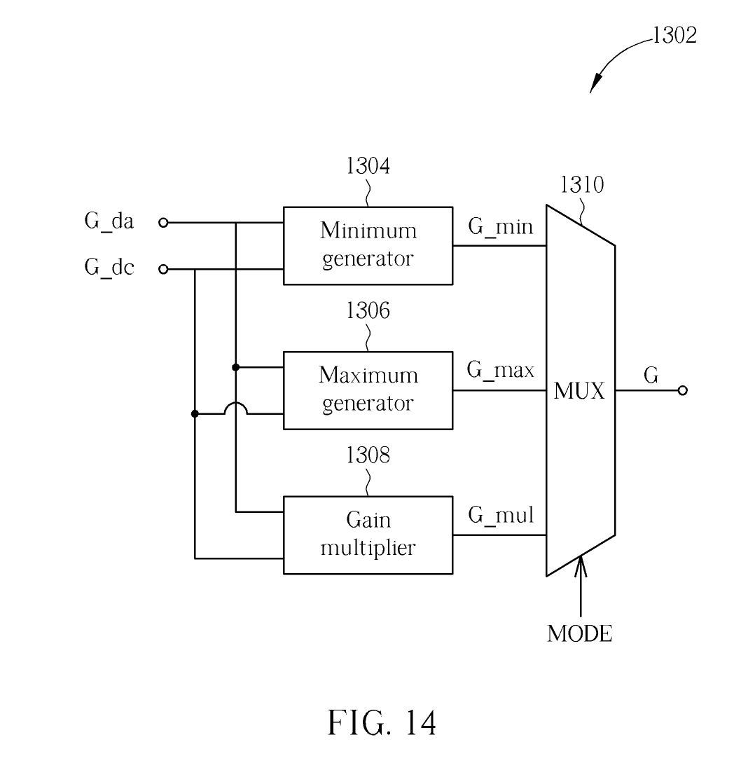

More specifically, please refer to FIG. 14, which is a schematic diagram of the gain selector 1302. The gain selector 1302 includes a minimum generator 1304, a maximum generator 1306, a gain multiplier 1308 and a multiplexer 1310. The minimum generator 1304, the maximum generator 1306 and the gain multiplier 1308 are respectively utilized for generating a minimum G_min, a maximum G_max and a product G_mul of the de-aliasing gain G_da and the de-contour gain G_dc. The multiplexer 1310 is utilized for selecting the minimum G_min, the maximum G_max or the product G_mul to be the gain G according to a display mode signal MODE. As a result, the user can evaluate practical image display quality and accordingly modify the gain G to suppress the aliasing patterns or the contour patterns.

Other elements and operations of the image transient improvement apparatus 1300 are identical to those of the image transient improvement apparatuses 50, 1000, and are not further narrated herein.

In the prior art, the image transient improvement apparatus 10 applies the constant gain G_f ix during the image sharpening process, causing side effects like aliasing and contour patterns in the image. In comparison, the present invention detects edges and complex patterns in the image IMG by calculating first-order and second-order derivatives to enhance the frequency component img_f by different gains, so as to suppress the aliasing or contour patterns in the image IMG.

To sum up, the present invention detects edges and complex patterns in the image by calculating first-order and second-order derivatives to adaptively adjust the gain, so as to suppress the aliasing or contour patterns in the image.

Those skilled in the art will readily observe that numerous modifications and alterations of the device and method may be made while retaining the teachings of the invention.

What is claimed is:

1. An image transient improvement apparatus for suppressing aliasing patterns in an image, the image transient improvement apparatus comprising:
an input end, for receiving a plurality of pixels of a sub-zone of the image;
an output end, for outputting a transient improved sub-zone of the image;
a limit detector, coupled to the input end, for detecting a maximum gray level and a minimum gray level of the plurality of pixels;
a filter, coupled to the input end, for acquiring a frequency component of the plurality of pixels at a specific frequency;
a weighted second-order derivative detector, coupled to the input end and the limit detector, for calculating a plurality of second-order derivatives of the plurality of pixels and generating a gain according to the plurality of second-order derivatives;
a multiplier, coupled to the filter and the weighted second-order derivative detector, for multiplying the frequency component by the gain to generate an amplified frequency component;
an adder, coupled to the multiplier and the input end, for calculating a sum of the amplified frequency component and the plurality of pixels; and
a limiter, coupled to the adder and the limit detector, for generating an input-output conversion function according to the maximum gray level and the minimum gray level, and converting the sum into the transient improved sub-zone.

2. The image transient improvement apparatus of claim 1, wherein the weighted second-order derivative detector comprises:
a plurality of second-order derivative calculators, each for calculating the second-order derivative of one of the plurality of pixels along a differential direction;
a weighted averaging unit, for calculating a weighted average of the plurality of second-order derivatives;
a normalization unit, for generating a local gain according to a difference between the maximum grey level and the minimum grey level, and multiplying the weighted average by the local gain to generate a normalization result; and
a gain adapter, for generating the gain according to the normalization result.

3. The image transient improvement apparatus of claim 2, wherein the differential direction is a horizontal direction, a vertical direction or a diagonal direction.

4. The image transient improvement apparatus of claim 2, wherein the second-order derivative is:
SD(x)=2*P(x)−P(x−Δ)−P(x+Δ);
wherein SD(x) represents the second-order derivative, P(x) represents a grey level of the pixel, Δ represents a pixel index difference, P(x−Δ) represents a grey level of a Δth previous pixel of the pixel along the differential direction, and P(x+Δ) represents a grey level of a Δth next pixel of the pixel along the differential direction.

5. The image transient improvement apparatus of claim 4, wherein the pixel index difference is 1 or 2.

6. The image transient improvement apparatus of claim 2, wherein the second-order derivative is:
SD(x)=max{2·P(x)−P(x−Δ)−P(x+Δ)2·P(x)−P(x−(Δ+1))−P(x+(Δ+1))}
wherein SD(x) represents the second-order derivative, P(x) represents a grey level of the pixel, Δ represents a pixel index difference, P(x−Δ) represents a grey level of a Δth previous pixel of the pixel along the differential direction, and P(x+Δ) represents a grey level of a Δth next pixel of the pixel along the differential direction.

7. The image transient improvement apparatus of claim 6, wherein the pixel index difference is 1.

8. The image transient improvement apparatus of claim 2, wherein the weighted average is an average of the plurality of second-order derivatives.

9. The image transient improvement apparatus of claim 2, wherein the weighted average is:
SD_avg=(SD(1)+SD(2)+ . . . 2×SD(m)+ . . . +SD(N))/(N+1);
wherein SD_avg represents the weighted average, N is an odd number representing a number of the plurality of second-order derivatives, SD(1), SD(2), . . . , SD(N) represent the plurality of second-order derivatives, and SD(m) represents a median of the plurality of second-order derivatives.

10. The image transient improvement apparatus of claim 2, wherein the normalization unit increases the local gain when the difference is small to enhance contrast of the sub-zone.

11. The image transient improvement apparatus of claim 2, wherein the gain adapter maintains the gain to be a standard gain when the normalization result is small.

12. The image transient improvement apparatus of claim 2, wherein the gain adapter decreases the gain when the normalization result is large to suppress aliasing patterns in the sub-zone.

13. The image transient improvement apparatus of claim 1, wherein the input-output conversion function is a sigmoid function with an upper output limit equal to the maximum grey level and a lower output limit equal to the minimum grey level.

14. An image transient improvement apparatus for suppressing contour patterns in an image, the image transient improvement apparatus comprising:
an input end, for receiving a plurality of pixels of a sub-zone of the image;
an output end, for outputting a transient improved sub-zone of the image;
a limit detector, coupled to the input end, for detecting a maximum gray level and a minimum gray level of the plurality of pixels;
a filter, coupled to the input end, for acquiring a frequency component of the plurality of pixels at a specific frequency;
an edge response detector, coupled to the input end, for calculating a plurality of first-order derivatives of the plurality of pixels, and generating a gain according to the plurality of first-order derivatives;
a multiplier, coupled to the filter and the edge response detector, for multiplying the frequency component by the gain to generate an amplified frequency component;
an adder, coupled to the multiplier and the input end, for calculating a sum of the amplified frequency component and the plurality of pixels; and
a limiter, coupled to the adder and the limit detector, for generating an input-output conversion function according to the maximum gray level and the minimum gray level, and converting the sum into the transient improved sub-zone.

15. The image transient improvement apparatus of claim 14, wherein the edge response detector comprises :
a first-order derivative calculator, for calculating the first-order derivative of each of the plurality of pixels along a differential direction; and
a gain adapter, for generating the gain according to the plurality of first-order derivatives.

16. The image transient improvement apparatus of claim 15, wherein the differential direction is a horizontal direction, a vertical direction or a diagonal direction.

17. The image transient improvement apparatus of claim 15, wherein the first-order derivative is:
FD(x)=abs(P(x)−P(x−Δ));
wherein FD(x) represents the first-order derivative, P(x) represents a grey level of the pixel, Δ represents a pixel index difference, and P(x−Δ) represents a grey level of a Δth previous pixel of the pixel along the differential direction.

18. The image transient improvement apparatus of claim 17, wherein the pixel index difference is 4, −4, 2 or −2.

19. The image transient improvement apparatus of claim 15, wherein the gain adapter decreases the gain when the first-order derivative is small to avoid the contour patterns in the image.

20. The image transient improvement apparatus of claim 15, wherein the gain adapter maintains the gain to be a standard gain when the first-order derivative is moderate.

21. The image transient improvement apparatus of claim 15, wherein the gain adapter reduces the gain when the first-order derivative is large to avoid enhancing shark edges in the image.

22. The image transient improvement apparatus of claim 14, wherein the input-output conversion function is a sigmoid function with an upper output limit equal to the maximum grey level and a lower output limit equal to the minimum grey level.

23. An image transient improvement apparatus for suppressing aliasing and contour patterns in an image, the image transient improvement apparatus comprising:
an input end, for receiving a plurality of pixels of a sub-zone of the image;
an output end, for outputting a transient improved sub-zone of the image;
a limit detector, coupled to the input end, for detecting a maximum gray level and a minimum gray level of the plurality of pixels;
a filter, coupled to the input end, for acquiring a frequency component of the plurality of pixels at a specific frequency;
a weighted second-order derivative detector, coupled to the input end and the limit detector, for calculating a plurality of second-order derivatives of the plurality of pixels and generating a de-aliasing gain according to the plurality of second-order derivatives;
an edge response detector, coupled to the input end, for calculating a plurality of first-order derivatives of the plurality of pixels, and generating a de-contour gain according to the plurality of first-order derivatives;
a gain selector, coupled to the weighted second-order derivative detector and the edge response detector, for generating a gain according to the de-aliasing gain and the de-contour gain;
a first multiplier, coupled to the gain selector and the filter, for multiplying the frequency component by the gain to generate an amplified frequency component;
an adder, coupled to the first multiplier and the input end, for calculating a sum of the amplified frequency component and the plurality of pixels; and
a limiter, coupled to the adder and the limit detector, for generating an input-output conversion function according to the maximum gray level and the minimum gray level, and converting the sum into the transient improved sub-zone.

24. The image transient improvement apparatus of claim 23, wherein the weighted second-order derivative detector comprises:
a plurality of second-order derivative calculators, each for calculating the second-order derivative of one of the plurality of pixels along a differential direction;
a weighted averaging unit, for calculating a weighted average of the plurality of second-order derivatives;
a normalization unit, for generating a local gain according to a difference between the maximum grey level an the minimum grey level, and multiplying the weighted average by the local gain to generate a normalization result; and
a gain adapter, for generating the de-aliasing gain according to the normalization result.

25. The image transient improvement apparatus of claim 24, wherein the differential direction is a horizontal direction, a vertical direction or a diagonal direction.

26. The image transient improvement apparatus of claim 24, wherein the second-order derivative is:
SD(x)=2*P(x)−P(x−Δ)−P(x+Δ);
wherein SD(x) represents the second-order derivative, P(x) represents a grey level of the pixel, Δ represents a pixel index difference, P(x−Δ) represents a grey level of a Δth previous pixel of the pixel along the differential direction, and P(x+Δ) represents a grey level of a Δth next pixel of the pixel along the differential direction.

27. The image transient improvement apparatus of claim 26, wherein the pixel index difference is 1 or 2.

28. The image transient improvement apparatus of claim 24, wherein the second-order derivative is:
SD(x)=max{2·P(x)−P(x−Δ)−P(x+Δ)2·P(x)−P(x−(Δ+1))−P(x+(Δ+1))}
wherein SD(x) represents the second-order derivative, P(x) represents a grey level of the pixel, Δ represents a pixel index difference, P(x−Δ) represents a grey level of a Δth previous pixel of the pixel along the differential direction, and P(x+Δ) represents a grey level of a Δth next pixel of the pixel along the differential direction.

29. The image transient improvement apparatus of claim 28, wherein the pixel index difference is 1.

30. The image transient improvement apparatus of claim 24, wherein the weighted average is an average of the plurality of second-order derivatives.

31. The image transient improvement apparatus of claim 24, wherein the weighted average is:
SD_avg=(SD(1)+SD(2)+ . . . 2•SD(m)+ . . . +SD(N))/(N+1);
wherein SD_avg represents the weighted average, N is an odd number representing a number of the plurality of second-order derivatives, SD(1), SD(2), . . . , SD(N) represent the plurality of second-order derivatives, and SD(m) represents a median of the plurality of second-order derivatives.

32. The image transient improvement apparatus of claim 24, wherein the normalization unit increases the local gain when the difference is small to enhance contrast of the sub-zone.

33. The image transient improvement apparatus of claim 24, wherein the gain adapter maintains the gain to be a standard gain when the normalization result is small.

34. The image transient improvement apparatus of claim 24, wherein the gain adapter decreases the gain when the normalization result is large to suppress aliasing patterns in the sub-zone.

35. The image transient improvement apparatus of claim 23, wherein the edge response detector comprises:
a first-order derivative calculator, for calculating the first-order derivative of each of the plurality of pixels along a differential direction; and
a gain adapter, for generating the de-contour gain according to the plurality of first-order derivatives.

36. The image transient improvement apparatus of claim 35, wherein the differential direction is a horizontal direction, a vertical direction or a diagonal direction.

37. The image transient improvement apparatus of claim 35, wherein the first-order derivative is:
FD(x)=abs(P(x)−P(x−Δ));
wherein FD(x) represents the first-order derivative, P(x) represents a grey level of the pixel, Δ represents a pixel index difference, and P(x−Δ) represents a grey level of a Δth previous pixel of the pixel along the differential direction.

38. The image transient improvement apparatus of claim 37, wherein the pixel index difference is 4, −4, 2 or −2.

39. The image transient improvement apparatus of claim 35, wherein the gain adapter decreases the gain when the first-order derivative is small to avoid the contour patterns in the image.

40. The image transient improvement apparatus of claim 35, wherein the gain adapter maintains the gain to be a standard gain when the first-order derivative is moderate.

41. The image transient improvement apparatus of claim 35, wherein the gain adapter reduces the gain when the first-order derivative is large to avoid enhancing shark edges in the image.

42. The image transient improvement apparatus of claim 23, wherein the gain selector comprises:
a minimum generator, for generating a minimum of the de-aliasing gain and the de-contour gain;
a maximum generator, for generating a maximum of the de-aliasing gain and the de-contour gain;
a gain multiplier, for calculating a product of the de-aliasing gain and the de-contour gain; and
a multiplexer, for selecting the minimum, the maximum or the product to be the gain according to a display mode signal.

43. The image transient improvement apparatus of claim 23, wherein the input-output conversion function is a sigmoid function with an upper output limit equal to the maximum grey level and a lower output limit equal to the minimum grey level.
